(19) United States
(12) Patent Application Publication
(10) Pub. No.: US 2026/0257176 A1
(43) Pub. Date: Sep. 3, 2026

(54) GAP-VARYING, LIFTED HELE-SHAW CELL (LHSC) FOR CONTROLLED LIQUID FILM FLOW AND DEVICES CONTAINING THE SAME

(71) Applicants: INDIAN INSTITUTE OF TECHNOLOGY BOMBY, Mumbai (IN); ACHIRA LABS PRIVATE LIMITED, Bengaluru (IN)

(72) Inventors: Prasanna S Gandhi, Mumbai (IN); Uddipta Singha, Mumbai (IN); Dhananjaya Dendukuri, Bengaluru (IN)

(73) Assignees: INDIAN INSTITUTE OF TECHNOLOGY BOMBY, Mumbai (IN); ACHIRA LABS PRIVATE LIMITED, Bengaluru (IN)

(21) Appl. No.: 19/164,116

(22) PCT Filed: Sep. 22, 2023
(86) PCT No.: PCT/IB2023/059387

§ 371 Date: Sep. 10, 2025

(30) Foreign Application Priority Data
Mar. 10, 2023 (IN) 202321016073

(51) Int. Cl. B01D 61/18; B01D 63/08; B01D 69/06

(52) U.S. Cl. CPC B01D 61/18; B01D 63/087; B01D 69/06

(57) ABSTRACT

The present invention relates to a controlled radial flow of a circular liquid film by gap-varying Lifted Hele Shaw Cell (LHSC) to provide bi-directional repeated radial flow, with varying cell gap. The present invention more particularly relates to a lifted “Hele-Shaw cell” (LHSC) with radial flow of a circular liquid film comprising top plate (1), bottom plate (3) and circular liquid film (2) in between the said two plates, characterised in that the top plate comprises spherical cap and the bottom plate is flat, providing a bi-directional repeated radial flow of the circular liquid film with a varying cell gap. The present invention further relates to a suspension micro-filtration device based on the LHSC and its applications in biotechnology.

### FIELD OF INVENTION

The present invention relates to a controlled liquid film flow in Lifted Hele-Shaw Cell. The present invention more particularly relates to a sphere-on-flat lifted Hele-Shaw Cell with a varying cell gap. The present invention further relates to micro-filtration device based on the gap-varying LHSC and its applications in biotechnology.

### BACKGROUND OF INVENTION

Hele-Shaw flow is defined as Stokes flow between two parallel flat plates separated by an infinitesimally small gap. Various problems in fluid mechanics can be approximated to Hele-Shaw flows and thus the research of these flows is of importance. Approximation to Hele-Shaw flow is specifically important to micro-flows. This is due to manufacturing techniques, which creates shallow planar configurations, and the typically low Reynolds numbers of micro-flows.

A typical lifted Hele-Shaw flow typically comprises flat and parallel plates to each other, wherein a fixed quantity of fluid is subjected to two-step process. It is first squeezed between two thinly-spaced surfaces (‘plates’). Then plates are separated thus allowing the fluid film to retract. The fluid may be of any viscosity greater than that of air, and it may be pure liquid or suspension of particles. The radially stretched film has small aspect ratio (ratio between the film thickness and the radius) in the order of 1/100 or less. During plate separation, low-viscosity air penetrates the outer interface of a contracting high-viscosity fluid domain, and can result in finger formation at the film interface. To characterize this ‘Saffman-Taylor instability’, two key process parameters may be controlled: the film aspect ratio, and the plate separation speed. The LHSC has been used primarily for studying this instability and its applications.

The ordinary LHSC described above has uniform ‘cell gap’ (gap between surfaces). The gap between the plates of the cell is an important parameter affecting the flow dynamics. It is observed that a minimum gap is required to observe rigorous fingering instability. The onset time of instability, as well as the width of the fingers, increases with an increment in the gap due to a decrease in the convection. During plate separation, thin liquid films retract and get confined in regions of minimum cell gap due to liquid surface tension. This phenomenon is utilized to guide the retracting film into regions of minimum cell gap in the flow.

Radially-varying ‘cell gap’ profiles allow for thickness control and can produce fluid films or fluid structures of varying heights for different applications. The modified ‘cell gap’ may or may not be axisymmetric so that a variety of flows can take place in the LHSC, to produce different liquid pattern.

Taper-induced control of viscous fingering in variable-gap Hele-Shaw flows Eduardo O. Dias and José A. Miranda Phys. Rev. E 87, 053015 Published 22 May 2013 DOI: 10.1103/PhysRevE.87.053015. Eduardo O Dias et. al, reports a taper-induced control of viscous fingering in variable-gap Hele-Shaw flows. A non-axisymmetric gap profile is shown in Eduardo O Dias et. al, where the plate separation leads to liquid retraction in a manner such that the film is finally focused at the location of minimum gap. In a constant gap profile, the film would have retracted to its centre or to positions of minimum gap resulting from small non-parallelism of the plates seen practically. The straight-tapered plate has the potential of causing damage to the micro particles/cells used.

The straight-tapered radially-increasing gap variation (conical geometry), which is discussed in existing literature, has a sharp point at the centre leading to the possibility of asymmetry in the gaps because of small manufacturing and assembly tolerances such as tilt of plate.

Behavior of a Liquid Drop between Two Nonparallel Plates (DOI: 10.1021/la500512e). Cheng Lu et al report the behaviour of a liquid drop between two non-parallel plates. One of the plates is kept flat, while the other is inclined at a small angle. Depending on conditions identified through a physical model, the droplet may be transported horizontally towards the corner of the plates. This flow is driven by the difference in pressures at the two edges of the confined droplet. Hence, a difference in tilt will alter the droplet motion during plate separation.

The problem identified in the state of the art is that the stretched droplet, especially for low-viscosity liquids, does not get repeatedly positioned at the centre of the film because of small non-parallelism.

IN202021034604 relates to an apparatus for fabricating high aspect ratio structures comprising of flat and parallel plates, with an array of source holes to form mesh like structures, this helps in controlling viscous fingering by providing tree-like patterns that guide air entry. However, this does not necessarily control liquid flow in low-viscous liquids, or provide a robust system, with multiple use.

There is still a long felt need to develop a system that provides repeatedly positioned stretched droplets, at the centre of the film, especially for low-viscosity liquids, with controlled liquid flow, and higher efficiency.

The present inventors have surprisingly found that a non-parallel geometry, with one spherical plate provides a method for radial flow of a circular liquid film. The present invention provides a liquid film that is stretched and relaxed in a lifted Sphere on Flat-Hele-Shaw cell with bidirectional repeated flow of the bound film.

Bi-directional, repeated flow of the bound film on a circular area is achieved by straight-line motion of one or both of the plates. The micro-filtration device of the present invention utilizes multiple fluid phenomena like capillarity and shear migration of particles to maintain clog-free filtration.

The gap variation of the present invention is more useful, especially for low-viscosity fluid applications. The present invention also provides for a device based on the principle for filtration of droplet volume of particulate suspension and applications thereof.

### OBJECTS OF THE INVENTION

It is an object of the present invention to provide a gap-varying lifted “Hele-Shaw cell” (LHSC) with radial flow of a circular liquid film with a varying cell gap.

It is an object of the present invention to provide a method for radial flow of a circular liquid film. This radial flow can be achieved through relative motion between the two plates, effected manually or automatically.

It is another object of the present invention to provide a device for a bi-directional repeated flow of the bound film on a circular area.

It is another object of the present invention to provide a device free from complicated fabrication steps, wastage of input sample or its preprocessing, and long operation times commonly seen in existing devices.

It is yet another object of the present invention to provide a robust device with higher magnitudes of shear rate.

It is yet another objective of the present invention to provide a device with enhanced robustness in flow control and interface stability.

It is yet another object of the present invention to provide a device that can separate a broad-spectrum of suspension liquids.

### SUMMARY OF THE INVENTION

According to an aspect of the present invention there is provided a gap-varying, lifted “Hele-Shaw cell” (LHSC) with radial flow of a circular liquid film comprising:
i. top plate with spherical or nearly spherical cap (1);
ii. flat bottom plate (3); and
iii. circular liquid film (2) in between the said two plates;
   characterised in that the top plate comprises spherical or nearly spherical cap (1) and the bottom plate is flat, providing a bi-directional repeated radial flow of the circular liquid film with a varying cell gap.

According to another aspect of the present invention there is provided a suspension micro-filtration device based on the gap-varying LHSC wherein the said device comprises of:
a. top plate with spherical cap (1),
b. flat a bottom plate (3) comprising of:
   i. a circular groove (41) with two extending arms, acting as a barrier to constrain liquid extracted from the suspension,
   ii. a microchannel (42) that pulls and collects the liquid,
   iii. a thin polymer disc (43) attached to the surface at the centre of the groove,
   iv. a circular filter membrane (44) assembled over the disc (43) where edge of the membrane is secured on the bottom plate using tape (47) on three corners and a polymer laminate (45) on the fourth corner, wherein the disc (43) raises the membrane at its centre and creates a radially-symmetric wedge-shaped space between the membrane and bottom surface, and;
c. a circular liquid film (48) between the top plate and membrane surface.

According to another aspect of the present invention there is provided a method of filtration based on the gap varying LHSC comprising the steps of:
i. placing suspension droplet at the central disc (43);
ii. squeezing the suspension against the filter membrane (44) by bringing top plate with spherical cap (1) and bottom plate (3) together;
iii. separating the top and bottom plates (1, 3) to an extent to break the liquid bridge (46) to move the filtrate radially outward from the central region to microchannel mouth (49) and fill the microchannel (50);
iv. draining the filtrate in the microchannel (42) through outlet (51) with micro-pipette or tubing attached to suction pump to collect the filtrate.

According to yet another aspect of the present invention there is provided a hand operated filtration device comprising:
polymer bellow (61);
motion-limiting stop (62),
vent valve-closed (63);
push plate (64);
release plate (65);
vent valve-open (66), and
gap varying lifted Hele-Shaw cell (LHSC) with radial flow of a circular liquid film comprising:
   i. top plate with spherical cap (1);
   ii. flat bottom plate (3); and
   iii. circular liquid film (2) in between the said two plates.

According to another aspect of the present invention there is provided a device for batch processing of blood sample for large-scale plasma separation comprising:
reservoir (71);
flushing liquid reservoir (72) and input control valve (73) and
gap-varying lifted Hele-Shaw cell (LHSC) with radial flow of a circular liquid film comprising:
   i. top plate with spherical cap (1);
   ii. flat bottom plate (3); and
   iii. circular liquid film (2) in between the said two plates.

### BRIEF DESCRIPTION OF THE DRAWINGS

FIG. 1: A tapered lifted Hele-Shaw cell with arbitrary, non-axisymmetric gap variation of the present invention.

FIG. 2a: A gap varying sphere-on flat Lifted Hele Shaw cell apparatus of the present invention.

FIG. 2b: The movement of the circular liquid film on squeezing and separation of the plates of the gap varying SOF-LHSC FIG. 3: An embodiment of the invention with a plurality of spherical cap-shaped profiles on the plates.

FIG. 4: The bottom plate of a suspension filtration device based on an embodiment of the present invention.

FIG. 5: The suspension filtration process according to an embodiment of the invention.

FIG. 6: A cross-sectional view of a hand operated embodiment of the filtration device disclosed in the present invention.

FIG. 7: An embodiment of the present invention for batch-wise processing of blood sample for large-scale plasma separation.

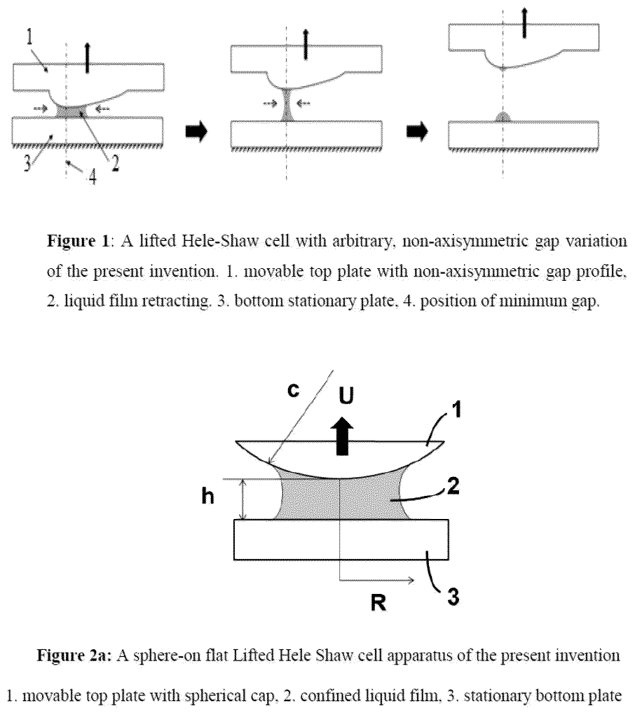

### DETAILED DESCRIPTION OF THE INVENTION

The following description with reference to the accompanying drawings is provided to assist in a comprehensive understanding of exemplary embodiments of the invention. It includes various specific details to assist in that understanding but these are to be regarded as merely exemplary.

Accordingly, those of ordinary skill in the art will recognize that various changes and modifications of the embodiments described herein can be made without departing from the scope of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the scope of the invention as defined by the appended claims and their equivalents.

It is to be understood that the singular forms “a,” “an,” and “the” include plural referents unless the context clearly dictates otherwise.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, steps or components but does not preclude the presence or addition of one or more other features, steps, components or groups thereof.

The term “spherical or nearly spherical” includes spherical, convex, ovoid, elliptical, oval, or parabolic creating axisymmetric or non-axisymmetric gap profiles.

The present invention relates to a device for radial flow of a circular liquid film through various modifications in the ‘cell gap’. During plate separation, thin liquid films retract and get confined in regions of minimum cell gap due to liquid surface tension. This phenomenon is utilized to guide the retracting film into regions of minimum cell gap in the flow. Radially-varying ‘cell gap’ profiles allow for thickness control and can produce fluid films or fluid structures of varying heights for different applications. The modified ‘cell gap’ may or may not be axisymmetric so that a variety of flows can take place in the LHSC, to produce different liquid patterns; referred as “gap varying”. A non-axisymmetric gap profile is shown in figure-1, where the movable top plate with nearly spherical cap creating non-axisymmetric gap profile (1) and bottom stationary plate (3) separation leads to liquid retraction in a manner such that the film is finally focused at the location of minimum gap (4). In a constant gap profile, the film (2) would have retracted to its centre or to positions of minimum gap resulting from small non-parallelism of the plates seen practically. The asymmetry of flow in a constant-gap LHSC, results from small, unavoidable non-parallelism of the two plates, which results in undesirable off-centre flow.

‘Cell gap’ with axisymmetric radial variation can be used to stabilise otherwise unstable film retraction in the LHSC. A radially-increasing gap profile in linear fashion (straight-tapered LHSC) has been theoretically shown to demonstrate suppression of fingering instability in existing literature. The present disclosure proposes, in addition, several other profiles for enhanced robustness in flow control and interface stability.

According to the most preferred embodiment of the present invention there is provided a gap-varying lifted “Hele-Shaw cell” (LHSC) with radial flow of a circular liquid film comprising of:
i. top plate with spherical or nearly spherical cap (1);
ii. flat bottom plate (3); and
iii. circular liquid film (2) in between the said two plates;
   characterised in that the top plate comprises spherical cap (1) and the bottom plate is flat, providing a bi-directional repeated radial flow of the circular liquid film with a varying cell gap while ensuring a high shear rate to aid in clog-free filtration.

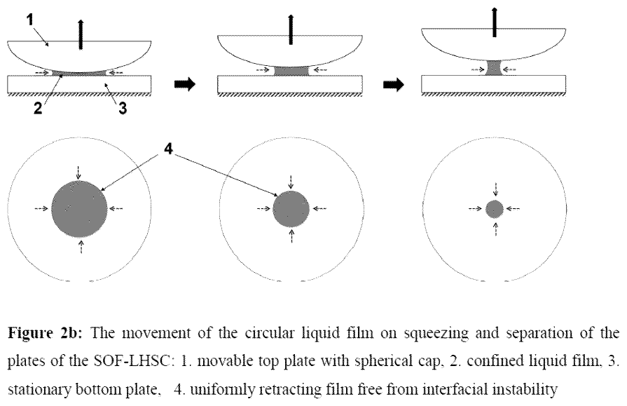

In the present invention there is provided a smooth radially-increasing gap profile in a lifted Hele-Shaw Cell, by using a spherical plate (spherical cap) as one of the two surfaces. This geometry is here-on referred to as the sphere-on-flat (SOF) geometry and is shown in FIG. 2a. Interface stability may be achieved during plate separation in the sphere-on-flat, lifted ‘Hele-Shaw cell’ (SOF-LHSC), even under higher plate separation speeds depending on the curvature of the plate. In absence of varying cell gap, higher speeds will lead to instability of the interface. The fingering instability-free circular shape of the interface can be robustly maintained during both squeezing and separation of the cell plates, shown in FIG. 2b.

FIG. 2a discloses the sphere-on-flat, lifted Hele-Shaw Cell (SOF-LHSC) of the present invention, with a top plate with spherical cap (1) as a movable top plate, a circular liquid film (2) and a stationary bottom plate (3). Radius of curvature of spherical plate (c) is found to be the third control parameter in addition to the aforementioned squeezed film aspect ratio comprising of minimum film thickness (h) and film radius (R), and plate separation velocity (U).

FIG. 2b, shows the shape of the liquid film, during squeezing and separation of the cell plates. The uniformly retracting film free from interfacial instability can be seen in FIG. 2b (4).

In an embodiment of the invention, due to the varying cell gap in the present gap varying LHSC or SOF-LHSC, there is a suppression of ‘particle-induced viscous fingering’ at the edges of the squeezed film during squeezing of particulate suspensions, which is otherwise observed in a constant-gap LHSC. Such fingering can be avoided in the present invention when the localized resuspension of particles is undesirable for any application.

In an embodiment of the invention, flow of the liquid is further controlled by gap-gradient, anisotropy-based methods, and by spatial variations of wettability used alternatively or in combination.

In an embodiment of the invention, anisotropies including but not limited to pits, lands and holes are present on at least one plate of the device for controlled penetration of air into the liquid film. These anisotropies help in formation of finger-like fluid structures form a symmetric pattern called the ‘Cayley tree’ with good repeatability/Experiments can be performed in both the stable and unstable regimes in the gap varying, SOF-LHSC for controlled shaping of liquid film. For a fixed aspect ratio and plate curvature, a critical plate separation speed exists. Below this speed, smooth circular interfaces may be ensured. Above the critical speed, finger-like fluid structures form a symmetric pattern called the ‘Cayley tree’, can be precisely obtained with good repeatability by use of anisotropies on one or both of the plate surfaces. Examples of anisotropies include pits, lands and holes which have been previously reported for controlled penetration of air into the liquid film.

In another embodiment of the invention, another cell-gap modification is proposed to control liquid flow by providing a gap-gradient, where one of the plates may be modified in such a way that a plurality of spherical cap-shaped profiles is placed in a repetitive pattern over the flow area. Ports may be drilled in a suitable pattern in between the undulations. Ports are kept sealed during liquid squeeze, and opened during plate separation to allow entry of air to shape the contracting liquid bridges until they collapse by necking. As a result, discrete liquid islands/spots may be obtained at the locations of minimum cell gap. Such liquid islands may also be of varying sizes depending on the sizes of the undulations and the pitch of the pattern. As previously reported, the pattern of such islands may be controlled by the pattern of undulations in the modified surface. For example, a regular and staggered array of undulations will lead to square and hexagonal arrangement of liquid islands respectively. Due to radial nature of the flow in the LHSC, circumferential patterns may also be produced using circumferential anisotropy such as annular grooves.

FIG. 3 shows the process of separation with modifications in the cell-gap as disclosed in the above embodiment, wherein the plate is modified with a plurality of spherical cap-shaped profiles (1), with ports (8) in between the undulations, that are sealed (5) during squeeze and opened during plate separation to allow entry of air to shape the contracting liquid bridges (6) until they collapse by necking. As a result, discrete liquid islands/spots (7) may be obtained at the locations of minimum cell gap.

In an embodiment of the invention, and additional way of control of flow of the liquid film is provided by incorporation of spatial variations of wettability on plate surfaces. The substrates may also be subjected to various exposure-based or chemical-based treatments to alter the wettability, locally or completely, to further manipulate the flows by attracting or repelling the liquid film. These alterations may be used in combination with aforementioned gap-gradient and anisotropy-based methods.

In another embodiment of the invention, either one or both of the plates can be made movable as relative motion between the plates is required. The movable plate may be actuated by mounting on a linear motion stage run by an electric motor. The plate speed may be kept constant or it may be varied according to a speed profile. High-frequency oscillatory motion may be imparted to the plate to homogenize the particle distribution in the suspension fluid film before start of the process, if sample is prone to sedimentation. The plate motion may also be carried out by hand when precise plate speed is not necessary.

In an embodiment of the invention, the gap varying, lifted ‘Hele-Shaw cell’ (LHSC) is provided as a device for separation of cells/particles from suspension. A simple robust suspension microfiltration device is disclosed. The device has a top plate with spherical cap (1), and a bottom plate (3) with circular liquid film (2) in between the two plates. The device is simple yet robust, and there is no requirement of lithography-based fabrication steps. The top plate of device (spherical cap) and bottom plate are made of polymer. Oscillatory motion between two plates will lead to radial oscillatory flow of the sandwiched liquid film on the surface. Radial film flow speed is non-linearly proportional to plate speed. The bi-directional radial flow in current invention leads to a combination of cross-flow and dead-end filtration to overcome the challenges of clogging, higher filtration time, dead volume loss and low filtrate yields.

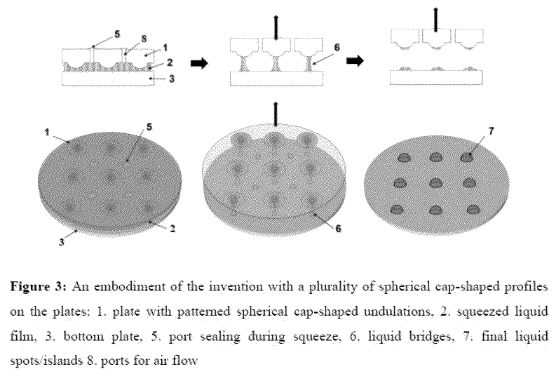

FIG. 4 shows a suspension micro-filtration device based on the gap-varying LHSC, characterized in that the said device comprises of
a. top plate comprising spherical cap (1),
b. flat a bottom plate (3);
c. a circular liquid film (48) between the two plates.

The bottom plate (3) of device is made of polymer such as polymethylmethacrylate (PMMA) is most preferred. Other options are polycarbonate (PC), polystyrene (PS), polyvinyl chloride (PVC), Cyclo-olefincopolymer (COC) and shown in FIG. 4. The bottom plate comprises of a circular groove (41) with two extending arms, which acts as a barrier to constrain liquid extracted from the suspension, it further has a microchannel (42) that pulls and collects the liquid. A thin polymer disc (43) is attached to the surface at the centre of the groove and a circular filter membrane (44) is assembled over the disc (43). The diameter of the circular membrane (44) is kept greater than the groove outer diameter, so that the outer part of the membrane is always un-wetted. Filter membrane is made of polymer and has pore size much less than the size of particle size, and very high pore density. The edge of the membrane is secured on the bottom plate using tape (47) on three corners and a polymer laminate (45) on the fourth corner. The disc (43) raises the membrane at its centre and creates a radially-symmetric wedge-shaped space between the membrane and bottom surface.

In an embodiment of the present invention, the circular groove (41) and the microchannel (42) is produced by one of variety of methods including micro-milling, laser machining, injection moulding.

In an embodiment of the present invention, the microchannel (42) pulls and collects the filtrate liquid, by capillary action or chemical-induced channel hydrophilicity or a combination of both.

The spreading and retraction of the suspension droplet takes place on the top side of the membrane. A uniform circular shape of the film (48) is maintained during gap-varying LHSC flow. This ensures repeatable flow of suspension film for efficient device operation. The present invention utilizes the pressure developed in the liquid film during ‘Hele-Shaw cell’ plate motion, to drive the filtrate past the membrane. Membrane pores restrict the particles by particle size-based exclusion, and allow only particle-free liquid part of suspension to seep into the space between membrane and bottom substrate, and form a thin film. The liquid part of suspension is then drained from the sub-membrane space at the microchannel mouth (49) by capillary action to fill the microchannel (50). Liquid fills the channel and is subsequently collected from microchannel outlet (51). The groove (41) acts as liquid barrier and limits the area (46) wetted by liquid film. The nature of the hydrophilic polymer membrane is such that the filtrate first wets the membrane, and then it flows by capillary action in the space below the membrane.

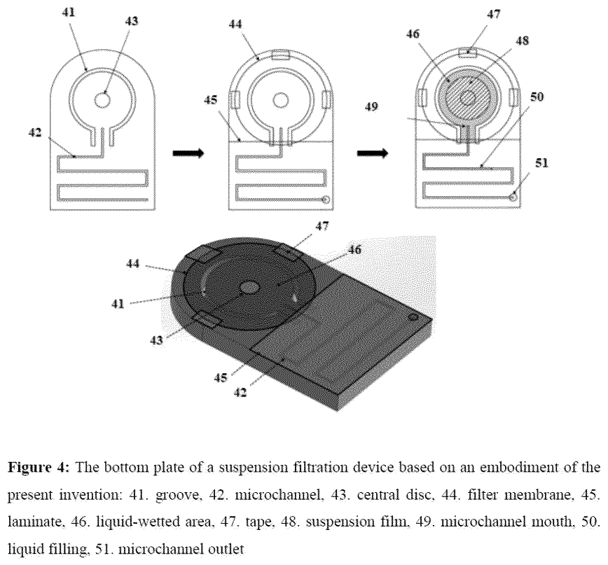

FIG. 5, discloses the suspension filtration process in detail. Suspension droplet is first placed at centre in Step-A. When the plates (1, 3) are brought together in Step-B, the suspension is squeezed against the filter membrane, and liquid part of suspension fills the sub-membrane space. Plate separation (Step-C) applies an upward pull on the deformable membrane due to fluid forces in liquid bridge. This creates radially-decreasing, wedge-shaped space below the membrane. Liquid is propelled towards the peripheral edge of the membrane where the mouth of output channel is positioned. Thus, the membrane itself serves the purpose of repositioning the separated filtrate below the membrane. Fresh filtrate is allowed to seep through the membrane by virtue of positive pressure in the subsequent squeezing stroke. Due to capillary pressure, the filtrate prefers to move radially outward from the central region and into the microchannel. The plates are separated to an extent that the liquid bridge breaks (Step-D) so that film pressure is released. These three processes in succession: film squeeze, plate separation, and bridge break, constitute one cycle. Such a cycle may be repeated as many times as required, in order to increase the liquid output volume filling the output microchannel. The filtrate flux through the membrane is proportional to the transmembrane pressure across the filter. Higher plate velocity creates higher pressure difference. Once adequately filled with liquid, micro-channel can be drained (Step-E) by micro-pipette or tubing attached to suction pump. A rubber-like polymer interface can be used to hold the pipette tip our pump tubing in a sealed contact against the outlet hole. Output liquid/filtrate may be stored in Eppendorf tubes for subsequent analyses to monitor filtration efficiency.

In an embodiment, the microfluidic channel dimensions may be controlled to collect different output volumes and channel cross-section may be of any shape. Microchannel can be made hydrophilic for enhanced liquid transport by various methods suitable for polymers such as chemical coating methods, ultraviolet radiation or oxygen-plasma treatment. Channel has its point of entry under the filter membrane, towards its periphery. The initial portion of the channel mouth is made sloping so that the liquid encounters a gradient of depth varying from the plane of the bottom plate to the maximum channel depth. This eliminates bubble formation at the mouth as liquid initially fills the channel. The remaining portion of the microfluidic channel is covered by a polymer laminate (hydrophilic). The laminate has a hole at end of channel which is the liquid outlet. For dense suspensions, device may be primed with neutral liquid to saturate small volumes in the sub-membrane space and activate channel filling.

In another embodiment, a bi-directional flow strategy is adopted for the filtration device by squeezing and releasing the drop of suspension repeatedly. Such a cyclic process has clear advantages: (i) unclogging of the pores; (ii) preventing particle damage, and (iii) re-circulation of a small amount of suspension to approach higher liquid yield. In the present invention, one can achieve re-circulation of a limited quantity of starting volume of suspension, with efficient use of limited filter area. This eliminates the need for dilution of the sample and eliminates clogging which is a major drawback in microfiltration-based devices as it restricts the filtrate passage. It occurs due to the formation of a concentration-polarized layer adjacent to the filter surface for cross-flow filtration.

In another embodiment, clogging is prevented by shear-induced migration of micro particles adjacent to the membrane surface that increases the filtrate flux through the membrane. The viscous lift force to drive the micro particles away from the pores of the membrane is a function of the shear rate in the flow domain, and may be controlled using the plate velocity and the film aspect ratio. Compared to constant gap and conical gap variations of the LHSC, higher shear rates are possible in the flow domain for the gap-varying LHSC system.

According to an embodiment there is provided a hand operated filtration device comprising
polymer bellow (61);
motion-limiting stop (62),
vent valve-closed (63);
push plate (64);
release plate (65);
vent valve-open (66), and
gap varying lifted “Hele-Shaw cell” (LHSC) with radial flow of a circular liquid film comprising:
   i. top plate with spherical cap (1);
   ii. flat bottom plate (3); and
   iii. circular liquid film (2) in between the said two plates

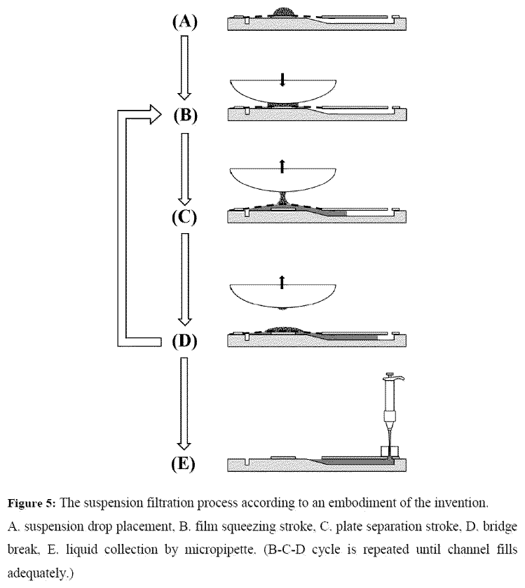

In an alternate embodiment, FIG. 6 shows a hand-operated embodiment of the filtration device where the two plates are joined by corrugated polymer bellow (61), a valved vent (63) shows the vent valve when closed, and valved vent (66) shows the vent valve when open in the bellow allows for pressure build-up in squeezing stroke (64) and pressure release in plate separation stroke (65). After placing suspension droplet on bottom plate (filtration chip) and assembling the top plate, finger/thumb may be used to push down the top plate repeatedly. Elasticity of bellow ensures spring-back action for plate separation stroke. The accidental damage of microparticles because of the spherical surface touching the flat membrane can be avoided by use of motion-limiting stop (62). Use of bellow (61) limits evaporation of small volumes of filtrate is and sample contamination is also prevented. Tilt of the top plate while pressing down will not affect device operation because of the spherical nature of the top surface. Hand-operated variant has reduced complexity, good portability, and is suitable for field use because the device requires no external accessory or powered equipment like pumps, etc.

In another embodiment, the micro filtration device can be used as a blood-plasma separator to separate red blood cells from plasma in whole blood ranging from microliter to millilitre volumes, and extract the plasma for diagnostic applications. The filtration device described so far is scalable in size to handle higher or lower liquid volumes of blood. As the aspect ratio is typically very small, a large area spread is obtained from a small volume of blood, thus utilizing filter area for plasma transfer. Another advantage of using proposed invention for blood-plasma separation is the use of non-specialized (and hence low-cost), and widely available membranes with constant pore size; unlike current filter-based technologies which require specialized asymmetric pore membranes for plasma extraction.

The present invention can enable the separation of plasma from small volumes (05-50 microliters) of undiluted blood that can come from a human finger prick, and is relevant for home-use applications.

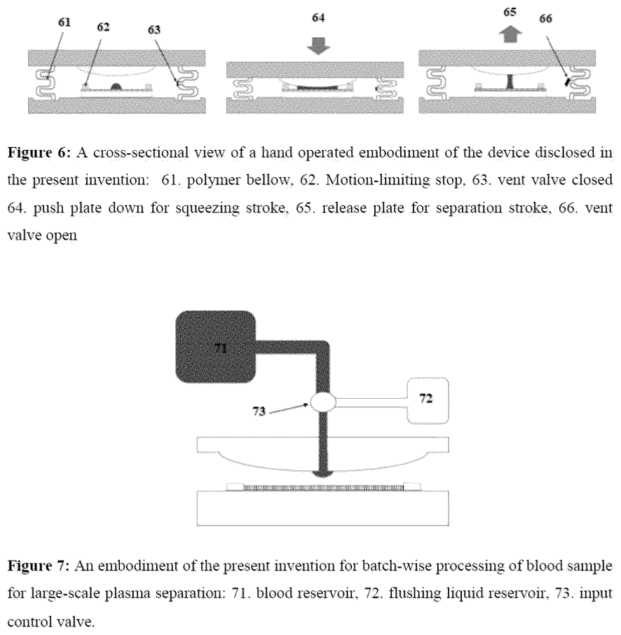

In an embodiment, for large-scale blood-plasma separation, batch processing of the filtration process is also proposed, by periodical introduction of fresh blood sample from a blood reservoir (71) through an inlet through centre of the top plate with spherical cap as shown in FIG. 7. Flushing liquid from the flushing liquid reservoir (72) may be used to clean and prime the membrane at regular intervals. Input valve (73) can be used to control flow into the device. The filtration device is capable of handling dense suspension like undiluted blood.

In addition to extraction of plasma volume for biological assay, on-chip assays colorimetric or fluorometric may also be positioned on the surface below the membrane where the cell-free plasma comes in contact with the bottom substrate. Such assays may also be positioned in the outlet microchannel itself.

According to another preferred embodiment there is provided a device for batch processing of blood sample for large-scale plasma separation comprising reservoir (71); flushing liquid reservoir (72) and input control valve (73) comprising gap-varying lifted “Hele-Shaw cell” (LHSC) with radial flow of a circular liquid film of the present invention is provided for biochemical analyses.

In another variant, the blood plasma may also be made to flow to pre-functionalized assay spots as shown at the end of the radial arms on the bottom substrate. Such spatially-defined regions may be produced by wettability modifications. Multiple assays of same or different kinds may be placed in the assay spots for simultaneous biochemical analyses. Such assays may also be laid out in array format and blood sample may be split and filtered, as described in (FIG. 3).

The various embodiments of the present invention provide for a Bi-directional, repeated radial flow of the circular liquid film, wherein the device is free from complicated fabrication steps, wastage of input sample or its pre-processing, and long operation times commonly seen in existing devices.

It is to be understood that the present invention is susceptible to modifications, changes and adaptations by those skilled in the art. Such modifications, changes, adaptations are intended to be within the scope of the present invention.

1. A gap-varying lifted Hele-Shaw cell LHSC) with radial flow of a circular liquid film comprising:
i. top plate with spherical or nearly spherical cap (1);
ii. flat bottom plate (3); and
iii. circular liquid film (2) in between the said two plates;
characterised in that the top plate comprises spherical or nearly spherical cap (1) and the bottom plate is flat, providing a bi-directional repeated radial flow of the circular liquid film with a varying cell gap.

2. The gap varying lifted Hele-Shaw cell (LHSC) with radial flow of a circular liquid film as claimed in claim 1 wherein the top plate is nearly spherical cap creating axisymmetric or non-axisymmetric gap profile.

3. The gap-varying LHSC as claimed in claim 1, wherein top plate comprises plurality of spherical caps (1), placed in a repetitive pattern over flow area with ports (8) drilled in between the spherical cap-shaped profiles (1).

4. The gap-varying LHSC as claimed in claim 1, wherein the fingering instability-free circular shape of the film is maintained during both squeezing and separation of cell plates.

5. The gap-varying LHSC as claimed in claim 1, wherein the varying cell gap is a smooth radially-increasing cell gap profile.

6. A suspension micro-filtration device based on the gap-varying LHSC, characterized in that the said device comprises of
a. top plate comprising spherical cap (1),
b. a flat bottom plate (3) comprising of:
i. a circular groove (41) with two extending arms, acting as a barrier to constrain liquid extracted from the suspension,
ii. a microchannel (42) that pulls and collects the liquid,
iii. a thin polymer disc (43) attached to the surface at the centre of the groove,
iv. a circular filter membrane (44) assembled over the disc (43) where edge of the membrane is secured on the bottom plate using tape (47) on three corners and a polymer laminate (45) on the fourth corner, wherein the disc (43) raises the membrane at its centre and creates a radially-symmetric wedge-shaped space between the membrane and bottom surface, and;
c. a circular liquid film (48) between the two plates.

7. The suspension micro-filtration device based on the gap-varying LHSC as claimed in claim 6 wherein the top plate comprises spherical cap (1) providing a bi-directional repeated radial flow of the circular liquid film with a varying cell gap, while ensuring a high shear rate to aid in clog-free filtration.

8. The suspension micro-filtration device based on the gap-varying LHSC as claimed in claim 6 wherein top plate comprises plurality of spherical caps (1), placed in a repetitive pattern over flow area with ports (8) drilled in between the spherical cap-shaped profiles (1).

9. The suspension filtration device as claimed in claim 6, wherein the diameter of the circular filter membrane is greater than that of the circular groove (41).

10. The suspension filtration device as claimed in claim 6, wherein either one or both of the two plates are movable.

11. The suspension filtration device as claimed in claim 8, wherein the ports (8) are kept sealed (5) during liquid squeeze, and opened during plate separation to shape contracting liquid bridges (6).

12. A method of filtration based on the gap varying LHSC comprising the steps of:
i. placing suspension droplet at the central disc (43);
ii. squeezing the suspension against the filter membrane (44) by bringing top plate with spherical cap (1) and flat bottom plate (3) together;
iii. separating the top and bottom plates (1, 3) to an extent to break the liquid bridge (46) to move the filtrate radially outward from the central region to microchannel mouth (49) and fill the microchannel (50);
iv. draining the filtrate in the microchannel (42) through outlet (51) with micro-pipette or tubing attached to suction pump to collect the filtrate.

13. A hand operated filtration device comprising
polymer bellow (61);
motion-limiting stop (62),
vent valve-closed (63);
push plate (64);
release plate (65);
vent valve-open (66), and
gap-varying lifted Hele-Shaw cell (LHSC) with radial flow of a circular liquid film comprising:
i. top plate with spherical cap (1);
ii. flat bottom plate (3); and
iii. circular liquid film (2) in between the said two plates.

14. A device for batch processing of blood sample for large-scale plasma separation comprising:
reservoir (71);
flushing liquid reservoir (72) and input control valve (73) and
sphere-on flat lifted Hele-Shaw cell (LHSC) with radial flow of a circular liquid film comprising:
i. top plate with spherical cap (1);
ii. flat bottom plate (3); and
iii. circular liquid film (2) in between the said two plates.
